(19) United States
(12) Patent Application Publication
(10) Pub. No.: US 2008/0147268 A1
(43) Pub. Date: Jun. 19, 2008

(54) Method and apparatus for alternative performance of automobile features

(76) Inventor: Michael G. Fuller, San Jose, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/640,063

(22) Filed: Dec. 14, 2006

(51) Int. Cl. G06F 19/00; G06F 7/00; H04B 7/26

(52) U.S. Cl. 701/35; 701/36; 455/41.3

(57) ABSTRACT

A method and system for performing automobile features are disclosed. Upon communicating with a user device and receiving an indication of an event initiated from the communication, an automobile feature associated with the event is determined and an automobile module is directed to perform the automobile feature.

### FIELD OF THE INVENTION

The invention relates generally to the field of electronic automobile control and more specifically to the field of performing automobile features with electronic devices.

### BACKGROUND

Vehicle manufacturers build increasingly more features into today's automobiles. Among those features is remote keyless entry, whereby a key fob signals a receiver in the car to unlock one or more doors. Typically, key fobs include additional automobile features, such as rolling windows up or down, unlocking or opening the trunk, or initiating a panic alarm. There are a wide variety of possible automobile features that a key fob may perform. For example, some key fobs have even been designed to start the automobile.

Key fob capability may either come installed with the automobile at the time of manufacture or installed at a later time. Today, many automobiles are sold with key fob capability already installed in the automobile. Automobile users may even purchase additional key fobs for their vehicle at a later date.

Key fobs are typically designed to be carried on a key chain along with the keys to the automobile. Since the key fob is usually attached to the keys, key fobs usually do not assist in the ever so common problem of locking the keys in the automobile. While automobile users may have an extra key fob or extra set of keys, they do not usually carry both sets with them. Typically, the extra set is kept at home or given to another person. Therefore, the automobile user would be required to locate and retrieve the extra set before it could be of any assistance. This may be inconvenient depending on, for example, the time of day, location of the automobile, or accessibility of the person with the extra set.

Another common problem arises when an automobile user wishes to perform an automobile feature on his automobile but does not have the keys or key fob with him. Many times users may accidentally leave their keys behind, or even intentionally leave their keys behind if they are not planning on using their automobile. The user, for example, may have left his keys in the house or office, but wish to enter his automobile or roll down the windows while in the parking lot or garage. In order to do so, the user would be required to first walk back to the house or office. This may be inconvenient depending on the distance or time required to do so.

What is needed is a device that allows an automobile user to use other devices, besides the key fob, to perform automobile features.

### SUMMARY OF THE INVENTION

The present invention includes a system and method for performing an automobile feature. Upon communicating with a user device and receiving an indication of an event initiated from the communication, an automobile feature associated with the event is determined and an automobile module is directed to perform the automobile feature.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a high level system architecture according to one embodiment of the invention;

FIG. 2 is a flow diagram showing a process of directing an automobile module to perform an automobile feature according to one embodiment of the invention.

FIG. 3 illustrates components of a described device according to one embodiment of the invention;

FIG. 4a illustrates components of a Bluetooth module within a described device according to one embodiment of the invention;

FIG. 4b illustrates components of a RF module within a described device according to one embodiment of the invention;

FIG. 5 is a flow diagram showing a process of directing an automobile module to perform an automobile feature according to one embodiment of the invention;

FIG. 6 illustrates components of a described device according on embodiment of the invention; and

FIG. 7 is a flow diagram showing a process of directing an automobile module to perform an automobile feature according to one embodiment of the invention.

### DETAILED DESCRIPTION

In the following description, numerous specific details are set forth in order to provide a thorough understanding of the present invention. It will be apparent, however, to one skilled in the art that these specific details need not be employed to practice the present invention. In other instances, well known materials or methods have not been described in detail in order to avoid unnecessarily obscuring the present invention.

Note that in this description, references to “one embodiment” or “an embodiment” mean that the feature being referred to is included in at least one embodiment of the invention. Moreover, separate references to “one embodiment” in this description do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

A method and apparatus for executing a feature on an automobile are described. In one embodiment, a device coupled to the automobile is described which allows a user to execute features on an automobile by using a user device.

### Exemplary Architecture

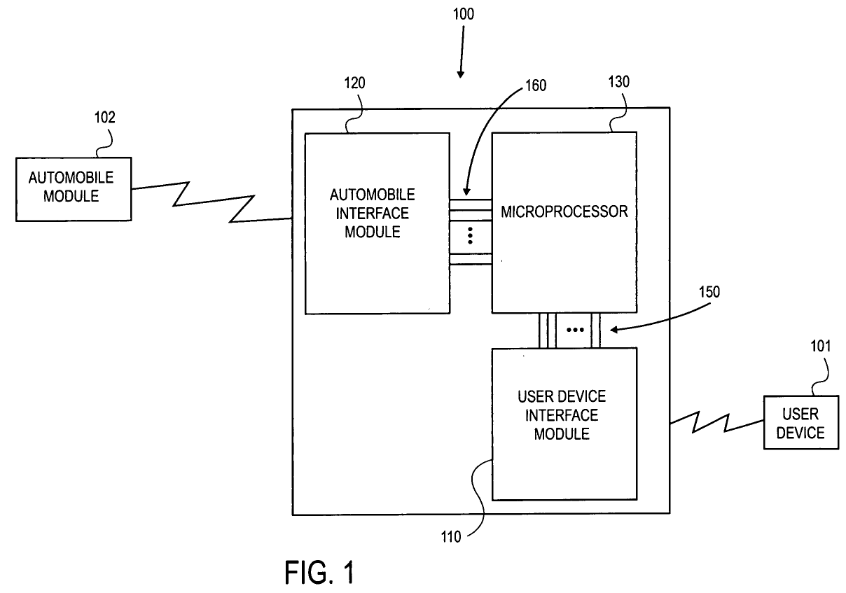

FIG. 1 illustrates a system architecture according to one embodiment of the invention. Device 100 includes a user device interface module 110, an automobile interface module 120, and a microcontroller 130 which communicates with user device interface module 110 and automobile interface module 120 via data lines 150 and command lines 160, respectively. User device interface module 110 may, for example, include a commercially available Bluetooth chip or infrared transceiver. Automobile interface module 120 may include, for example, a commercially available RF chip to transmit RF signals or an input/output cell specifically designed to communicate with a diagnostic port of an automobile. Microcontroller 130 may contain internal memory, or may be coupled to external memory (not shown), where initialization and configuration data are stored to be used by the microcontroller 130. In one embodiment, the microcontroller 130 has a built-in Erasable Programmable Read Only Memory (EPROM) for storing program instructions.

Device 100 allows a user to perform automobile features on an automobile with a user device 101. During operation, device 100 is coupled to the automobile and is capable of communicating with a user device 101 operated by a user wishing to perform an automobile feature. Device 100 is also capable of communicating with an automobile module 102 within the automobile that executes the automobile features for the automobile.

User device interface module 110 communicates with a user device 101 via wire-line or wireless technology, e.g. RF, visible light, invisible light, or sonic. For instance, the two devices may communicate via a connection in accordance with IEEE 802 standards. Wireless technologies may involve, for example, IEEE 802.11 Wireless LAN (Local Area Network) standards like 802.11a (operating in the 5 GHz band), 802.11b and 802.11g (operating in the 2.4 GHz band), IEEE 802.15 Wireless PAN (Personal Area Network) standard, Bluetooth which operates in the unlicensed industrial, scientific, and medical (ISM) band at 2.4 to 2.485 GHz, or infrared technology like infrared data association (IRDA). In one embodiment, user device 101 communicates with device 100 via a Bluetooth connection. In another embodiment, user device 101 communicates with device 100 via infrared connection. User device 101 may be any electronic device that may communicate with device 100, e.g. cell phone, Personal Digital Assistant (PDA), handheld electronic device, laptop, computer, etc.

Automobile interface module 120 may communicate with automobile module 102 via wire-line or wireless technology. Automobile module 102 may comprise a RF key fob receiving circuitry that is designed to receive RF signals from a RF key fob. The RF key fob receiving circuitry may be installed in the automobile upon manufacture or as an aftermarket installation. In one embodiment of the invention, the automobile interface module 120 transmits RF signals that emulate the RF signals from a RF key fob. These RF signals are subsequently received by the RF key fob receiving circuitry in the automobile module 102 which executes the appropriate automobile feature. In another embodiment, automobile interface module 120 and automobile module 102 interface through a diagnostic port of an automobile, wherein the automobile module 102 may comprise part of the automobile's electrical and computer system.

It should be appreciated that individual modules may be combined without compromising functionality, e.g. the microcontroller 130 and user device interface module 110 may be combined into a single module. Thus, the underlying principles of the invention are not limited to the specific modules shown.

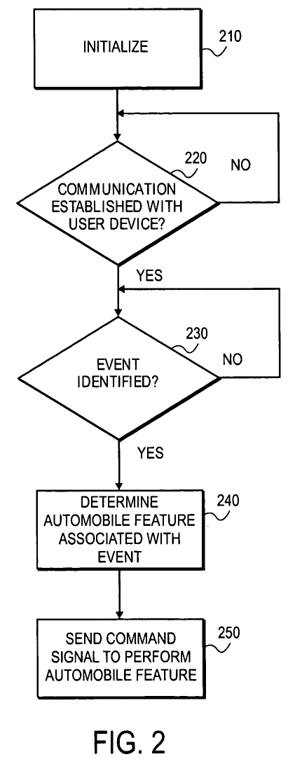

FIG. 2 illustrates a process of directing an automobile module to perform an automobile feature according to one embodiment of the invention. A software program may be utilized to implement the features of device 100.

At step 210, device 100 is initialized upon the supply of power, e.g. when the user turns on the device or plugs it into the automobile. During initialization, basic operation parameters of the microcontroller are configured. The microcontroller's random access memory (RAM) is initialized with the starting contents loaded from the ROM or other non-volatile solid-state memory. In one embodiment, the contents are loaded from a programmable space of the memory, which can be reprogrammed after the time of manufacture of device 100 and take into account user configurations of the device.

A cyclic-redundancy-check (CRC) may be performed to ensure that no errors occurred during the loading of the data into the RAM. If the CRC process fails, the microcontroller 130 may attempt to load the data from the memory into the RAM a few times, prior to reprogramming the memory with the default parameters stored in the microcontroller 130.

A sleep timeout counter may be used and set to a default value during the microcontroller initialization process. The sleep counter may be located in RAM and may be used to determine when the device should enter a low power mode. The counter periodically decrements until it reaches zero and then device 100 enters low power mode. The counter may, for example, be decremented every time the software goes through a whole processing loop. When the counter counts down to zero, the device goes to sleep. Once activity is detected, the counter is set to a default value again.

At step 220, user device interface module 110 and the user device 101 begin communication with each other. A user, for example, wishing to perform an automobile feature using a user device 101, e.g. his cell phone, may initiate communication with the user device interface module 110. User device 101 may, for example, be a Bluetooth-enabled device which scans for nearby Bluetooth devices, detects device 100 as such a device, and then begins communication with it. As another example, user device 101 may be an infrared enabled device which scans for nearby infrared devices, detects device 100 as such a device, and then begins communication with it. User device 101 may also be an 802 enabled device which scans for nearby 802 devices. It should be appreciated that the underlying principles of the invention are not limited to these specific wireless technologies and that a number of varying wireless and wire-line technologies may be used, as discussed earlier.

At step 230, microcontroller 130 waits for an indication of an event to occur before sending a command signal to perform an automobile feature associated with that event. The indication of the event is initiated from communication with the user device 101. In one embodiment, the event is a successful pairing of device 100 and the user device 101. A successful pairing may, for instance, comprise the user device 101 and device 100 successfully exchanging a security code or identification information. The user of the user device 101, for example, may attempt to pair with device 100 by entering an appropriate PIN or password. If the PIN/password is an acceptable code, then there is a successful pairing between the user device 101 and device 100. The successful pairing may, for example, occur via a Bluetooth, IEEE 802, or infrared communication. In another embodiment, an event is a downloading of a feature file from device 100 by the user device 101 (discussed in further detail later). However, it should be appreciated that the underlying principles of the invention are not limited to these specific exemplary definitions of an event.

At step 240, the microcontroller 130 determines which automobile feature is associated with the event that has occurred. For instance, microcontroller 130 may be preprogrammed to determine that the automobile feature of unlocking the doors is associated with a successful pairing of user device 101 and user device interface module 110. As another example, microcontroller 130 may be preprogrammed to determine that the automobile feature of rolling down the windows is associated with the download of a feature file titled “Roll Down Windows”. However, it should be appreciated that the underlying principles of the invention are not limited to these specific exemplary associations described. Furthermore, the microcontroller 130 may be preprogrammed to recognize a single event or multiple events, which may be associated with a single automobile feature or multiple automobile features. Therefore, the underlying principles of the invention are also not limited to any specific number of preprogrammed automobile features or events.

At step 250, the microcontroller 130 sends a command signal to the automobile interface module 120 to direct the automobile module 102 to perform the determined automobile feature from step 240. The command signal may be sent to the automobile interface module 120 via one or more command lines 160. In one embodiment, upon receiving the command signal, the automobile interface module 120 transmits a RF signal that emulates the corresponding command signal from a RF key fob. The RF signal is received by automobile module 102 via its RF key fob receiving circuitry. In one embodiment, the command lines 160 may comprise a command line for each automobile feature possible from a RF key fob. The microcontroller 130 may then send a signal down the appropriate command line for the determined automobile feature from step 240. In another embodiment, a data communication channel is integrated into the automobile interface module 120 so at reduce the number of wiring interconnects and increase the flexibility in function selection. However, the underlying principles of the invention are not limited to a particular communication design between the microcontroller 130 and the automobile interface module 120.

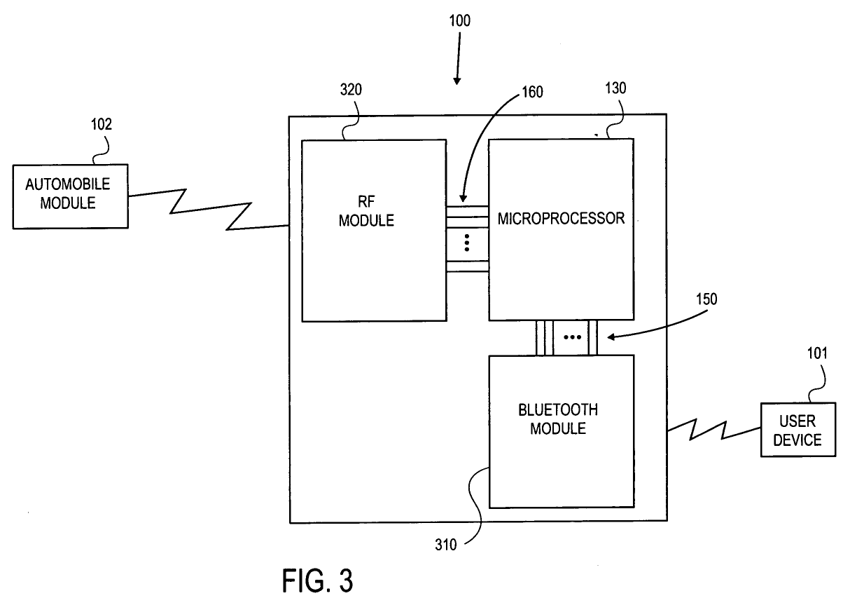

FIG. 3 illustrates components of device 100 according to one embodiment of the invention. In this exemplary embodiment, user device interface module 110 communicates with user device 101 via Bluetooth technology; thus, user device interface module 110 is represented in FIG. 3 as Bluetooth module 310. Furthermore, automobile interface module 120 transmits a RF signal to automobile module 102 which comprises a RF key fob receiving circuitry; thus, automobile interface module 120 is represented in FIG. 3 as a RF module 320.

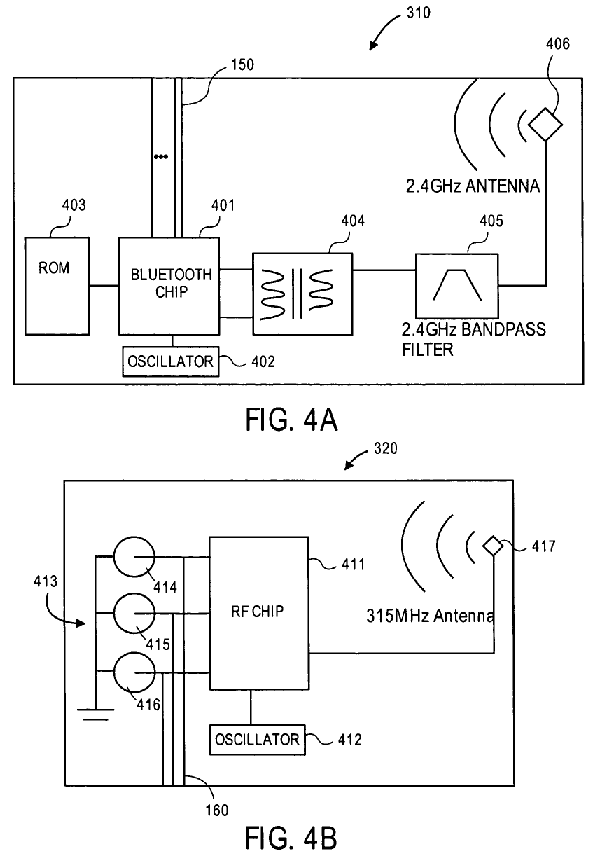

Microcontroller 130 interfaces to Bluetooth module 310 and RF module 320 via data lines 150 and command lines 160, respectively. The Bluetooth module 310 may communicate with a Bluetooth-enabled user device in proximity via Bluetooth wireless technology and is described in further detail in FIG. 4a. RF module 320 transmits a RF signal to automobile module 102 and is described in further detail in FIG. 4b.

In one embodiment, the microcontroller 130 interfaces to the Bluetooth module 310 through a universal asynchronous receiver/transmitter (UART) channel. The data lines 150, for example, may comprise a transmit (TX), receive (RX), and two flow control lines (RTS & CTS). The TX and RX of one device connect to the RX and TX of the other device, respectively. Likewise, the CTS and RTS of one device connect to the RTS and CTS of the other device, respectively. In this way, microcontroller 130 and Bluetooth module 310 may send data to each other and also indicate when it is too busy to receive data. In another embodiment, data lines 150 also comprise an additional interrupt line so that microcontroller 130 can be notified anytime Bluetooth module 310 needs attention and subsequently begin communication with it. In this way, the microcontroller may sleep and save power whenever the Bluetooth module 310 is waiting for user interaction. In yet another embodiment, data lines 150 comprise data lines for a USB or other common interface. However, it should be appreciated that the underlying principles of the invention are not limited to a particular type of communication interface.

FIG. 4a illustrates components of Bluetooth module 310 according to one embodiment of the invention. Bluetooth chip 401 is shown coupled to an oscillator 402 and external ROM 403 which contains the Bluetooth software that runs on Bluetooth chip 401. While an external ROM is shown for this exemplary embodiment, it should be appreciated that the underlying principles of the invention are not limited to an external ROM. For instance, flash memory may be used or the Bluetooth chip may include built-in ROMs or flash memory. The Bluetooth chip 401 may comprise all the necessary digital (microcontroller) and analog (radio) circuitry to operate as a completed Bluetooth device. The Bluetooth chip 401 may generate a balanced RF signal that is fed into an external balun transformer 404 which converts the signal to a single line that can be fed into an antenna 406. A bandpass filter is used to block unwanted frequencies from interfering with the Bluetooth communications. Furthermore, Bluetooth chip 401 communicates with microcontroller 130 via data lines 150.

FIG. 4b illustrates components of RF module 320 according to one embodiment of the invention. RF chip 411 may use a standard rolling code or other security technology to provide a secure link to the vehicle. The output of RF chip 411 drives antenna 417 which transmits the appropriate RF signal to automobile module 102 (not shown). Microcontroller 130 (not shown) is coupled to RF chip and may directly drive the automobile feature inputs 413 via command lines 160. In the exemplary embodiment shown, automobile feature inputs 413 comprise door lock 414, door unlock 415, and trunk release 416. In one embodiment, a command line may be present for each automobile feature possible where microcontroller 130 would provide the corresponding signal.

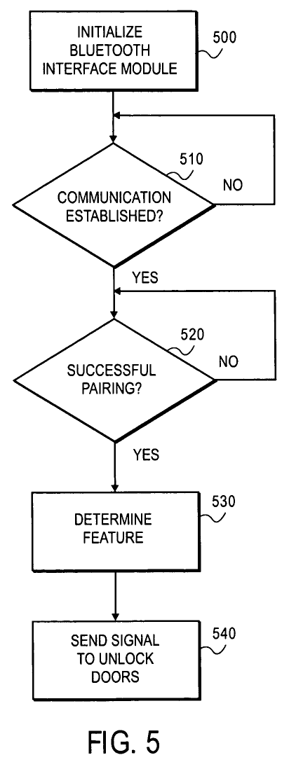

FIG. 5 illustrates an exemplary process of performing an automobile feature with device 100 according to one embodiment of the invention. In this exemplary process, the event is a successful pairing of the Bluetooth-enabled user device 101 and the associated automobile feature is unlocking the doors. At step 500, device 100 is initialized upon the supply of power to device 100, e.g. when the user turns on the device or plugs it into an automobile. At step 510, device 100 and the user device 101 begin communication with each other. For example, a user wishing to unlock his doors after locking his keys in the car may use his Bluetooth-enabled cell phone to initiate communication with device 100. At step 520, microcontroller 130 waits for an indication that Bluetooth module 310 and the user device 101 achieve a successful pairing. As described earlier for FIG. 2, a successful pairing may be achieved in numerous ways, e.g. by successfully exchanging a security code or identification information. Upon receiving an indication that a successful pairing has occurred, the microcontroller 130 determines that the automobile feature associated with the event is unlocking the doors, as represented at step 530. At step 540, the command signal to unlock the doors will be sent. Microcontroller 130 sends the appropriate command signal to the RF module 320 via command lines 160. In one embodiment, RF module 320 then directs automobile module 102 to unlock the doors by transmitting the corresponding RF signal. In another embodiment, the appropriate command signal is sent to the automobile module 102 via a diagnostics port of the automobile (described in further detail later).

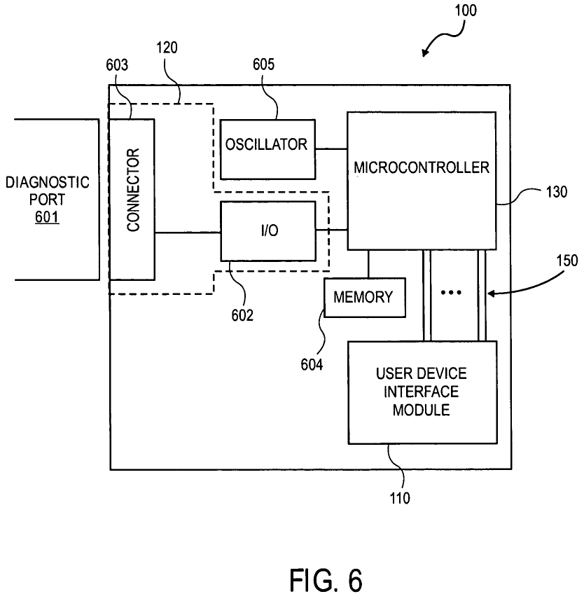

FIG. 6 illustrates components of device 100 according to one embodiment of the invention where device 100 communicates with the automobile module 102 via a diagnostic port of the automobile. The automobile module 102 may be the electrical system and computers within the automobile that are responsible for performing the automobile features. In one embodiment, the diagnostic port 12 is an on-board diagnostic-II (OBD-II) port coupled to the automobile's electrical system and computers through a bus line, and conforming to Title 13 California Code 1968.1 titled “Malfunction and Diagnostic System Requirements-1994 and Subsequent Model-Year Passenger Cars, Light-Duty Trucks, and Medium-Duty Vehicles and Engines,” filed on Aug. 27, 1990 to Air Resource Board (ARB). In another embodiment the diagnostic port 12 is any link to the wiring harness or bus line connecting the electrical components of the automobile to one another.

Device 100 comprises microcontroller 130 which couples to the diagnostic port 601 of the automobile through an I/O cell 602 and connector 603, all of which are mounted on a printed circuit board (PCB, not shown). The microcontroller 130 is coupled to a memory 604 where initialization and configuration data is stored to be used by the microcontroller 130.

In one embodiment, the microcontroller 130 has a built-in Erasable Programmable Read Only Memory (EPROM) for storing program instructions, which implement a protocol for a particular automobile, for example, a Chevrolet Corvette. An oscillator 605 couples to the microcontroller 130 and provides a clock signal of a frequency selected to operate with the microcontroller 130.

In one embodiment, the 10 cell 602 interfaces the microcontroller 130 to the automobile diagnostic port's bus in accordance with electrical requirements described in a corresponding specification published by the Society of Automotive Engineering. In one embodiment, the diagnostic port's bus is an OBD-II bus, electrical requirements of which are described in the SAE-J1850 specification titled “Class B Network Communications Interface.” In summary, the microcontroller's voltage levels, thresholds, and edge rates may be different and may need to be adjusted for compatibility with the automobile's bus. The IO cell 602 may interface with the microcontroller 130 through two digital signals: one input and one output. The automobile side, i.e. diagnostic port's electrical connection, is a single bi-directional line that meets the electrical requirements of the diagnostic port's bus. In one embodiment of the invention, the 10 cell 602 drives the OBD-II bus at voltages being 8V high, and 0V low when commanded by the microcontroller's digital output signal. The IO cell 602 may read the diagnostic port's bus and send a 5V high or 0V low digital signal. In one embodiment, the microcontroller 130 can read the input signal even when driving the output signal. This may allow the microcontroller to detect bus contention to support the bit-by-bit arbitration requirements of the OBD-II spec.

Furthermore, it should be noted that the automobile interface module 102 is functionally shown in FIG. 6 with a dotted line encompassing the I/O cell 602 and connector 603; however, the underlying principles of the invention are not limited to this particular functional drawing of the automobile interface module 102. For instance, the automobile interface module 102 could be functionally redrawn to include the microprocessor 130.

Additionally, it should be appreciated that in FIG. 6, microcontroller 130 may interface to user device interface module 110 via data lines 150 in the same manner as described earlier for previous embodiments. It will also be appreciated that previous discussion regarding user device interface module 110 and user device 101 are equally applicable in FIG. 6. For example, the user device interface module 110 and user device 101 may communicate with each other using Bluetooth, infrared, or IEEE 802 technology. Furthermore, it is well known in the art that individual modules may be combined without compromising functionality, e.g. the microcontroller 130 and user device interface module 110 may be combined into a single module. Thus, the underlying principles of the invention are not limited to the specific number of modules shown.

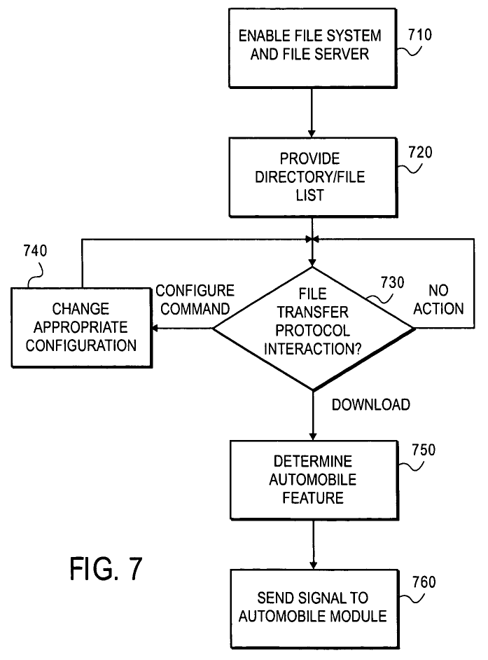

FIG. 7 illustrates a process of performing features of device 100 where device 100 utilizes existing protocols such as file transfer protocol (FTP) and/or Object Exchange (OBEX). The technical details of these protocols, as well as the use of these protocols with Bluetooth, IEEE 802, and infrared technology, are well known by those skilled in the art and are therefore not discussed in great detail. While many user devices today support newer technologies like Bluetooth, many older user devices do not. However, many of these legacy user devices support infrared technology. Making use of such existing protocols allows existing or legacy user devices to perform automobile features without requiring software upgrades. In one embodiment, feature files representing different automobile features are displayed on a user device for selection by a user.

At step 710, device 100 enables file system and runs file server so that the user device 101 may access feature files stored within device 100. At step 720, device 100 provides user device 101 with a directory or file list. This list may contain feature files which represent specific automobile features, e.g. unlocking the doors, opening the trunk, rolling down the windows, etc. At step 730, device 100 waits for a file transfer protocol interaction to be initiated. If the user, for instance, wishes to unlock the doors, the user may select the appropriate feature file on the user device 101 for download. The appropriate feature file may be nothing more than a text file named “unlock doors” which tells the user that the download has started and the doors are being unlocked. If the download of a feature file is established to be an event signaling the execution of an automobile feature, then the microcontroller 130 will determine what automobile feature is associated with the particular feature file downloaded, as represented at step 750. At step 760, microcontroller 130 sends the appropriate command signal to the automobile interface module 120 which sends a signal to the automobile module 102 to perform the determined automobile feature.

At step 730, device 100 may also receive a configuration file from the user device 101. The user, for instance, could use user device 101 to create a configuration file and send it to device 100 in order to set certain configuration parameters. A wide array of configuration parameters may be applicable. For example, PIN codes and passwords could be defined by the user; directories, menus and feature files may be named or renamed by the user; and/or authorized user device lists may be defined by the user to allow only certain user devices access. However, the underlying principles of the invention are not limited to these particular set of exemplary configuration parameters. After receiving the uploaded configuration command, microcontroller 130 makes the appropriate configuration changes at step 740 and proceeds to wait for another file transfer protocol interaction.

### Training the Device to Operate with a Particular Automobile

When device 100 comprises RF module 320, after initial installation it may be required to program the automobile to recognize device 100. Some automobiles today allow new fobs to be added to an existing list of valid fobs, while other automobiles may completely erase the list and require all valid fobs to be reconfigured again whenever a new fob is added. In one embodiment, device 100 comprises a configuration button which, when activated, allows the user to program the target automobile so that it recognizes device 100. The target automobile may be required to be in a “special mode” during such configuration, e.g. requiring the ignition key to be inserted into the automobile. The configuration button may serve a dual purpose: configuring device 100 to operate with the target automobile, and allowing the user to test the RF module 320 to make sure it is working properly with the target automobile. In another embodiment, a Bluetooth-enabled user device 101 instructs device 100 to enter a fob learning mode so that device 100 can be configured to operate with the target automobile.

### Location of the Device

During normal operation, device 100 is coupled to the automobile. For example, the device may be installed on or inside the automobile, or it may be removable and plugged into the vehicle during normal operation. In one embodiment, device 100 is connected into a diagnostic port in the automobile. Device 100 may be communicating with the automobile module through the diagnostic port and/or using the diagnostic port to power itself. In another embodiment, device 100 may be located inside the device described in U.S. Pat. No. 6,795,760, which is incorporated herein by reference. In yet another embodiment, device 100 is connected to the automobile's electrical and computer system. In yet another embodiment, device 100 wired as part of the automobile's car alarm system. In yet another embodiment, device 100 comprises a solar cell and battery and is located on or inside the automobile so that it may be exposed to sunlight. The use of a solar cell and battery for power purposes is well known in the art and are therefore not described in further detail.

It will be appreciated that the above-described system may be implemented in hardware or software, or by a combination of hardware and software. In one embodiment, the above-described system may be provided in a machine-readable medium. The machine-readable medium may include any mechanism that provides information in a form readable by a machine, e.g. a computer. For example, a machine-readable medium may include read only memory (ROM); random access memory (RAM), magnetic disk storage media; optical storage media; flash memory devices; electrical, optical, acoustical or other form of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
communicating with a user device;
receiving an indication of an event initiated from communication with the user device;
determining an automobile feature associated with the event; and
transmitting a wireless signal from a location on an automobile, wherein the wireless signal directs an automobile module to perform the automobile feature.

2. The method of claim 1 wherein the wireless signal is a RF signal.

3. The method of claim 2 wherein the event is a successful pairing with the user device.

4. The method of claim 3 wherein the automobile feature is unlocking a door.

5. The method of claim 3, wherein the successful pairing is achieved by a successful exchange of a security code over one connection selected from a group consisting of Bluetooth, IEEE 802, and infrared.

6. The method of claim 2 wherein the user device is at least one selected from a group consisting of a cell phone, PDA, handheld electronic device, laptop, and computer.

7. The method of claim 1 wherein the event is a download of a feature file to the user device.

8. The method of claim 7 wherein the download is via one connection selected from a group consisting of Bluetooth and IEEE 802.

9. The method of claim 7 wherein the download is via an infrared connection.

10. The method of claim 7 wherein the download utilizes a file transfer protocol.

11. The method of claim 7 further comprising:
receiving a configuration file from the user device; and
changing a configuration parameter according to the configuration file.

12. The method of claim 1 wherein the communication is one selected from a group consisting of RF, infrared, visible light, invisible light, and sonic.

13. The method of claim 1 wherein the communication is over a Bluetooth connection.

14. The method of claim 1 wherein the communication is over one connection selected from the group consisting of infrared and IEEE 802.

15. An apparatus comprising:
a user device interface module to communicate with a user device; and
an automobile interface module to transmit a wireless signal to an automobile module in response to an event initiated from communication with the user device, wherein the wireless signal directs the automobile module to perform an automobile feature on an automobile, wherein the automobile interface module is coupled to the automobile during the transmission of the wireless signal.

16. The apparatus of claim 15 wherein the wireless signal is a RF signal.

17. The apparatus of claim 15 wherein the user device is at least one selected from a group consisting of a cell phone, PDA, handheld electronic device, laptop, and computer.

18. The apparatus of claim 15 wherein the communication is over one connection selected from a group consisting of Bluetooth, IEEE 802 and infrared.

19. The apparatus of claim 15 wherein the event is a successful pairing with the user device.

20. The apparatus of claim 19, wherein the successful pairing is achieved by a successful exchange of a security code.

21. The apparatus of claim 19 wherein the successful pairing is achieved over a connection selected from a group consisting of Bluetooth, IEEE 802 and infrared.

22. The apparatus of claim 15 wherein the event is a download of a feature file to the user device.

23. The apparatus of claim 22 wherein the download is over one connection selected from a group consisting of Bluetooth, IEEE 802, and infrared.

24. The apparatus of claim 22 wherein the download utilizes a file transfer protocol.

25. The apparatus of claim 22 wherein the device receives a configuration file from the user and changes a configuration parameter according to the configuration file.

26. The apparatus of claim 15 wherein the communication is one selected from a group consisting of RF, infrared, visible light, invisible light, and sonic.

27. The apparatus of claim 15 wherein the communication is via one connection selected from a group consisting of Bluetooth, IEEE 802, and infrared.

28. The apparatus of claim 15 wherein the device is connected into a diagnostic port for power.

29. The apparatus of claim 15 wherein the device is connected into an electrical wiring of the automobile.

30. The apparatus of claim 15 wherein the device is wired into a car alarm.

31. The apparatus of claim 15 wherein the device comprises a solar cell and battery.

32. A processing system comprising:
a processor; and
a storage medium having stored therein instructions which, when executed by the processor, cause the processing system to perform a method comprising:
communicating with a user device;
receiving an indication of an event initiated from communication with the user device;
determining an automobile feature associated with the event; and
transmitting a wireless signal from a location on an automobile, wherein the wireless signal directs an automobile module to perform the automobile feature.

33. The processing system of claim 32 wherein the wireless signal is a RF signal.

34. The processing system of claim 32 wherein the user device is at least one selected from a group consisting of a cell phone, PDA, handheld electronic device, laptop, and computer.

35. The processing system of claim 32 wherein the communication is one selected from a group consisting of Bluetooth, IEEE 802, and infrared.

36. The processing system of claim 32 wherein the event is a successful pairing with the user device.

37. The processing system of claim 32 wherein the event is a download of a feature file to the user device.

38. A machine-readable medium that provides instructions, which when executed by a machine, cause the machine to perform operations comprising:
communicating with a user device;
receiving an indication of an event initiated from communication with the user device;
determining an automobile feature associated with the event; and
transmitting a wireless signal from a location on an automobile, wherein the wireless signal directs an automobile module to perform the automobile feature.

39. An apparatus comprising:
a means for communicating with a user device;
a means for receiving an indication of an event initiated from communication with the user device;
a means for determining an automobile feature associated with the event; and
a means for transmitting a wireless signal from a location on an automobile, wherein the wireless signal directs an automobile module to perform the automobile feature.

40. A method comprising:
communicating with a user device over a connection selected from the group consisting of Bluetooth, IEEE 802, and infrared;
receiving an indication of an event initiated from communication with the user device;
determining an automobile feature associated with the event; and
directing an automobile module to perform the automobile feature via a diagnostic port of an automobile.

41. The method of claim 40 wherein the directing comprises directing the automobile module via a diagnostic port's bus.

42. The method of claim 41 wherein the diagnostic port's bus is an OBD-II bus.

43. The method of claim 40 wherein the user device is a cell phone or personal digital assistant.

44. The method of claim 40 further comprising:
receiving a configuration file from the user device; and
changing a configuration parameter according to the configuration file.

45. The method of claim 40 wherein the event is a successful pairing with the user device.

46. The method of claim 40 wherein the event is a download of a feature file to the user device.

47. An apparatus comprising:
a user device interface module to communicate with a user device over a connection selected from the group consisting of Bluetooth, IEEE 802, and infrared;
input output lines to communicate with an automobile module of an automobile via a diagnostic port of the automobile, the communication with the automobile module directing the automobile module to perform an automobile feature in response to an event initiated from the communication with the user device.

48. The apparatus of claim 47 wherein the directing comprises directing the automobile module via a diagnostic port's bus.

49. The apparatus of claim 48 wherein the diagnostic port's bus is an OBD-II bus.

50. The apparatus of claim 47 wherein the device receives a configuration file from the user and changes a configuration parameter according to the configuration file.

51. The apparatus of claim 47 wherein the event is a successful pairing with the user device.

52. The apparatus of claim 47 wherein the event is a download of a feature file to the user device.

53. A processing system comprising:
a processor; and
a storage medium having stored therein instructions which, when executed by the processor, cause the processing system to perform a method comprising:
communicating with a user device over a connection selected from the group consisting of Bluetooth, IEEE 802, and infrared;
receiving an indication of an event initiated from communication with the user device;
determining an automobile feature associated with the event; and
directing an automobile module to perform the automobile feature via a diagnostic port of an automobile.

54. The processing system of claim 53 wherein the directing comprises directing the automobile module via a diagnostic port's bus.

55. The processing system of claim 53 wherein the diagnostic port's bus is an OBD-II bus.

56. The processing system of claim 53 wherein the device receives a configuration file from the user and changes a configuration parameter according to the configuration file.

57. The processing system of claim 53 wherein the event is a successful pairing with the user device.

58. The processing system of claim 53 wherein the event is a download of a feature file to the user device.

59. A machine-readable medium that provides instructions, which when executed by a machine, cause the machine to perform operations comprising:
communicating with a user device over a connection selected from the group consisting of Bluetooth, IEEE 802, and infrared;
receiving an indication of an event initiated from communication with the user device;
determining an automobile feature associated with the event; and
directing an automobile module to perform the automobile feature via a diagnostic port of an automobile.

60. The method of claim 59 wherein the event is a successful pairing with the user device.

61. The method of claim 59 wherein the event is a download of a feature file to the user device.

62. An apparatus comprising:
a means for communicating with a user device over a connection selected from the group consisting of Bluetooth, IEEE 802, and infrared;
a means for receiving an indication of an event initiated from communication with the user device;
a means for determining an automobile feature associated with the event; and
a means for directing an automobile module to perform the automobile feature via a diagnostic port of an automobile.
